(19) United States
(12) Patent Application Publication
(10) Pub. No.: US 2025/0259080 A1
(43) Pub. Date: Aug. 14, 2025

(54) SEMI-SUPERVISED SYSTEM FOR DOMAIN SPECIFIC SENTIMENT LEARNING

(71) Applicant: Visa International Service Association, San Francisco, CA (US)

(72) Inventors: Sheng Wang, Austin, TX (US); Peng Wu, Beaverton, OR (US); Xutong Wang, Austin, TX (US); Dan Wang, Cedar Park, TX (US); Jie Yuan, San Mateo, CA (US)

(73) Assignee: Visa International Service Association, San Francisco, CA (US)

(21) Appl. No.: 19/114,953

(22) PCT Filed: Sep. 25, 2023
(86) PCT No.: PCT/US2023/074988

§ 371 Date: Mar. 25, 2025

Related U.S. Application Data
(60) Provisional application No. 63/377,994, filed on Sep. 30, 2022.

(51) Int. Cl. G06N 5/022

(52) U.S. Cl. CPC G06N 5/022

(57) ABSTRACT

Automated computer systems and methods to determine a sentiment of information in digital information or content are disclosed. One aspect includes deriving, by a processor, the digital information from a source; generating, by the processor, a domain-specific machine learning sentiment score, based on the digital information, by one model of at least two machine learning models; autonomously mapping, by the processor, a non-domain specific knowledge graph of associations between elements in a set of digital contextual information; receiving, by the processor, sentiment graphs, each sentiment graph defining a sentiment; generating, by the processor, a graph sentiment score based on the non-domain specific knowledge graph and the sentiment graphs; generating, by the processor, a final sentiment score based on the graph sentiment score and the domain-specific machine learning sentiment score; and determining the sentiment of the information in the digital information or content via the final sentiment score.

### CROSS-REFERENCES TO OTHER APPLICATIONS

This application claims the benefit of and priority under 35 U.S.C. § 119(e) to U.S. Provisional Application No. 63/377,994, filed Sep. 20, 2023, entitled “SEMI-SUPERVISED SYSTEM FOR DOMAIN SPECIFIC SENTIMENT LEARNING,” the contents of which is hereby incorporated by reference in its entirety herein.

### TECHNICAL FIELD

The present technology pertains to systems and methods for training and enhancing machine learning networks to determine sentiment or tone of digital information, news items, and other information sources relating to specific domains. In particular, but not by way of limitation, the present technology pertains to systems and methods for semi-supervised domain specific sentiment learning.

### BACKGROUND

The training of machine learning networks using semi-supervised techniques produce outputs of varying usability and usefulness, especially in the area of information and news domain and sentiment categorization. There exists a need to improve the results of semi-supervised training models and enhance their outputs to generate more accurate and consistently usable results.

### BRIEF SUMMARY

In various aspects, the present disclosure provides a method to determine information sentiment in digital information, comprising deriving, by a processor, the digital information from a source; generating, by the processor, a domain-specific machine learning sentiment score, based on the digital information, by one model of at least two machine learning models; autonomously mapping, by the processor, a non-domain specific knowledge graph of associations between elements in a set of digital contextual information; receiving, by the processor, sentiment graphs, each sentiment graph defining a sentiment; generating, by the processor, a graph sentiment score based on the non-domain specific knowledge graph and the sentiment graphs; generating, by the processor, a final sentiment score based on the graph sentiment score and the domain-specific machine learning sentiment score; and determining, by the processor, the information sentiment in the digital information via the final sentiment score.

In various aspects the method may further comprise automatically updating entity attributes, in at least one of a database or server, based on the final sentiment score.

In various aspects, the method comprises, training a first machine learning model, with a base layer and a second layer, on the digital information; incorporating the base layer trained on the digital information into a second machine learning model; and training the second machine learning model, comprising the base layer and a final layer, to generate the domain-specific machine learning sentiment score. In some aspects, the training of the first machine learning model, includes training the first machine learning model to classify topics of the digital information.

In various aspects, generating of the graph sentiment score comprises determining a graph similarity, for each of the sentiment graphs, with the non-domain specific knowledge graph; applying the sentiment defined by each of the sentiment graphs to its determined graph similarity, to produce a graph-specific similarity-tone score; and combining the graph-specific similarity-tone score of the sentiment graphs.

In various aspects, the generating of the final sentiment score comprises applying a weighting to the graph sentiment score to generate a weighted graph sentiment score; applying another weighting to the domain-specific machine learning sentiment score to generate a weighted domain-specific machine learning sentiment score; and combining the weighted graph sentiment score and the weighted domain-specific machine learning sentiment score.

The elements in the method may also comprise at least one of an entity, a name, a location, a time, or an event. The method also may include at least a portion of the digital information being labeled. In some aspects of the method, the defined sentiment of each of the sentiment graph related to a digitally provided contextual scenario.

In various aspects, the present disclosure provides an automated system to define information sentiment in digital information, the system comprising at least one of a database or a server containing entity attributes; a processor; and a computer readable medium storing instructions executable by the processor, to derive, by the processor, the digital information from a source; generate, by the processor, a domain-specific machine learning sentiment score, based on the digital information, by one model of at least two machine learning models; autonomously map, by the processor, a non-domain specific knowledge graph of associations between elements in a set of digital contextual information; receive, by the processor, sentiment graphs, each sentiment graph defining a sentiment; generate, by the processor, a graph sentiment score based on the non-domain specific knowledge graph and the sentiment graphs; generate, by the processor, a final sentiment score based on the graph sentiment score and the domain-specific machine learning sentiment score; and determine, by the processor, the information sentiment in the digital information via the final sentiment score. In some aspects, the system also may comprise instructions to automatically update entity attributes, in the at least one database or server, based on the final sentiment score.

In various aspects, the automatic system includes instructions to train a first machine learning model, with a base layer and a second layer, on the digital information; incorporate the base layer trained on the digital information into a second machine learning model; and train the second machine learning model, comprising the base layer and a final layer, to generate the domain-specific machine learning sentiment score. In other aspects, the instructions to train the first machine learning model comprise instructions to train to classify topics of the digital information.

In various aspects, the automatic system includes instructions to generate the graph sentiment score comprising determine a graph similarity, for each of the sentiment graphs, with the non-domain specific knowledge graph; apply the sentiment defined by each of the sentiment graphs to its determined graph similarity, to produce a graph-specific similarity-tone score; and combine the graph-specific similarity-tone score of the sentiment graphs.

In various aspects, the system includes instructions to generate the final sentiment score comprise apply a weighting to the graph sentiment score to generate a weighted graph sentiment score; apply another weighting to the domain-specific machine learning sentiment score to generate a weighted machine learning sentiment score; and combine the weighted graph sentiment score and the weighted domain specific machine learning sentiment score.

In various aspects, the elements comprise at least one of an entity, a name, a location, a time, or an event. In some aspects at least a portion of the digital information is labeled. In some aspects, the defined sentiment of each sentiment graph relates to a digitally provided contextual scenario.

In various aspects, the present disclosure provides a non-transitory computer-readable storage medium having embodied thereon a program, the program executable by a processor to perform a method for providing a sentiment for digital information comprising: deriving, by a processor, the digital information from a source; generating, by the processor, a domain-specific machine learning sentiment score, based on the digital information, by one model of at least two machine learning models; autonomously mapping, by the processor, a non-domain specific knowledge graph of associations between elements in a set of digital contextual information; receiving, by the processor, sentiment graphs, each sentiment graph defining a sentiment; generating, by the processor, a graph sentiment score based on the non-domain specific knowledge graph and the sentiment graphs; generating, by the processor, a final sentiment score based on the graph sentiment score and the domain-specific machine learning sentiment score; and determining, by the processor, the information sentiment in the digital information via the final sentiment score.

In various aspects, the program executable by a processor to perform the method further comprises: automatically updating entity attributes, in at least one of a database or a server, based on the final sentiment score.

In various aspects, disclosed is an automated system to update stored entity attributes based on a determined sentiment for information, the system comprising a database containing entity attributes; a processor; and a computer readable medium storing instructions executable by the processor, to input, by the processor, domain-specific digital information received from a source into a trained domain-specific machine learning model; output, by the processor, a domain-specific sentiment score produced by the domain-specific machine learning model; input, by the processor, digital news information into a knowledge graph representing an entity; update, by the processor, the knowledge graph with the digital news information; determine, by the processor, a similarity of the knowledge graph with a defined sentiment graph to produce a graph sentiment score; generate, by the processor, an entity sentiment score, based on the domain-specific sentiment score and the graph sentiment score; look up, by the processor, an entity sentiment score entry stored in the database; and based on a difference between the entity sentiment score and the entity sentiment score entry, automatically update, by the processor, the entity sentiment score entry in the database.

In various aspects, a connected system consisting of a cluster of nodes to create and update entity profiles based on live information, the system comprising a plurality of nodes connected within the cluster; a first node of the plurality of nodes, in communication with a digital information channel, the first node comprising instructions executable to receive a digital information associated with an entity from the digital information channel; input the digital information into a trained ML network to generate a sentiment classification; output the sentiment classification into a processing node of the plurality of nodes; and a second node of the plurality of nodes in communication with a news source, the second node comprising instructions to receive digital news content from the news source; and map a knowledge graph associated with the entity based on the digital news content.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The methods and systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a diagram of a method to determine a sentiment in digital information, according to at least one aspect of the present disclosure.

FIG. 2 illustrates an entity graph representing a knowledge or sentiment knowledge graph, according to at least one aspect of the present disclosure.

FIG. 3 is a logic flow diagram of a method for determining sentiment in digital information, according to at least one aspect of the present disclosure.

FIG. 4 is a logic flow diagram of a method for training machine learning networks, according to at least one aspect of the present disclosure.

FIG. 5 is a flow diagram of a method for generating sentiment scores based on mapped graphs, according to at least one aspect of the present disclosure.

FIG. 6 is a block diagram of a computer apparatus, according to at least aspect of the present disclosure.

FIG. 7 is a diagrammatic representation of an example system that includes a host machine within which a set of instructions to perform any one or more of the methodologies discussed herein may be executed, according to at least one aspect of the present disclosure.

### DESCRIPTION

Before discussing specific aspects and examples, some descriptions of terms used herein are provided below.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. An “application” may be computer code or other data stored on a computer readable medium (e.g., memory element or secure element) that may be executable by a processor to complete a task.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may be a mobile device or a non-mobile device, such as a desktop computer. Furthermore, the term “computer” may refer to any computing device that includes the necessary components to send, receive, process, and/or output data, and normally includes a display device, a processor, a memory, an input device, a network interface, and/or the like.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. The term processor may also mean that a method disclosed herein can be practiced by distributed processors all under the control of one payment network server.

As used herein, the term “system” may refer to one or more computing devices or combinations of computing devices (e.g., processors, servers, client devices, software applications, components of such, and/or the like).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer or computing device, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system. A “user” may include an individual. In some aspects, a user may be associated with one or more personal accounts and/or mobile devices. The user may also be referred to as a cardholder, account holder, or consumer.

Information, current events, data, and news pieces are all factors in assessing the trustworthiness, credit risk, and other states of individuals and entities when building accurate assessments, entity, and risk profiles in order that automated decisions or updates to systems and/or databases can be made. For example, in the banking, lending, or credit industry, the profiles that are built for individuals, organizations, and other entities are used to design or provide customizable products to these entities. Operational teams routinely search for information, and news articles on companies or businesses to determine their credit-worthiness and risk, however, there is no necessarily objective view or understanding of what constitutes negative or positive indicators, tones, or sentiment regarding an entity in regards to one or more relevant domains, and no way to scale or automate the processes with current technologies in the art.

One way to scale these processes is by attempting to automate them using well-trained machine learning models that would be able to not only determine the categories and domains of information, news items, and the other data, but also to classify the sentiment(s) related to each contextual information, news item, or to entities in the provided information. However, it is difficult to automate such processes or train network models to make determinations of sentiment of contextual information relating to one or more entities. Some of the challenges faced when training autonomous models include the lack of available data, the lack of well-labelled information and data, the difficulty in categorizing information and domains based on this limited information and data, errors and biases in available data, and the significant cost and investment associated with obtaining data that is well-labelled and consistent in quality.

For example, training models on general domain labels such as eBay labeled data, or those derived from customer reviews from merchant websites such as Amazon, Delta airlines, or the like, or other similarly publicly available data, may contain sentiments that may be identified, but those sentiments may be unrelated to the use cases, domains, or topics required and that are of use. For example, a negative customer review on delta seating arrangements or in-flight entertainment may capture general customer sentiment about in-board satisfaction, but it is likely irrelevant to the credit worthiness or immediate bankruptcy risks of delta-airlines.

Another option to improve the relevance of data, is to filter data, or available information, based on keywords, the aim of this filtering or keywords approach is to select data that may be more relevant to the specific use-cases or network training models. However, filtering could be an overly blunt approach that is not a well-tuned option, this is because keywords or labels may take an overly broad or narrow approaches and the selection or use of specific words or phrases selected may include inherent biases (and the failure to select or use other words and phrases may also include inherent biases that will affect the data). A more refined approach that takes into account a more complete view of the contextual information is needed to accurately assess sentiments regarding entities for specific domains.

Presented herein are systems and methods to automatically determine sentiment in various news and digital information articles, by training, improving, and enhancing machine learning networks with non-domain specific entity graphs, and use sentiment determinations to update entity attributes, databases, and undertake automated changes and decisions based on built entity profiles and sentiment information. The goal of the presented systems and methods is to develop automatic, accurate, and efficient processes to extract, derive, find, and learn sentiments in contextual information for various domains, for different use cases. The presented technologies include two primary parts, the first, is to use ancillary information to train machine learning models to learn how to classify domains, and then to learn how to classify specific sentiments, with partially labeled and freely available data; and the second is to enhance these models with specifically tuned non-domain specific knowledge and sentiment graphs.

While different machine learning techniques for understanding languages exist, for example various Natural language processing techniques, machine learning models consistently fail to accurately derive sentiment from input information. Provided in this disclosure are techniques to more accurately derive, via machine learning models, sentiment from input information, such as but not limited to digital textual information, as well as techniques to train such machine learning models to improve their ability, reliability and accuracy in deriving sentiment from information inputs.

In various aspects of the present disclosure, improved sentiment derivation techniques allow the machine learning models presented herein to be incorporated into systems, such as corporate enterprise systems or networks (these referred to herein as “enterprise”), for example, to automatically and reliably update information stored in databases, or data warehouses based on the machine learning models' improved sentiment understanding outputs. Updating data automatically based on these machine learning models can only be undertaken if the machine learning models can be trusted to accurately derive sentiment information from various information sources, according to the models presented herein. For example, deriving sentiment information about individuals and/or entities in real-time, can cause the updates to sentiment levels/scores stored in databases of an enterprise, which can in turn affect various outcomes such as a credit or risk rating of an entity and therefore affect permissions and behaviors across the system.

As one non-limiting example, live news information about a coup in a country may cause the machine learning models presented herein to detect negative sentiment associated with the country, which may then be associated with entities doing business in or with that country or its related entities, or putting certain amount of business activity at risk causing their designated risk scores to increase. The enterprise system may use these new scores to update the entity/individual credit rating or trust worthiness, and based on preconfigured or predetermined thresholds, permissions for loans or loans of certain sizes may automatically be prevented across the enterprise network, with an automatic override mechanism. Of course the converse is also incorporated into the systems described herein, when positive sentiments are associated with entities, for example a successful IPO or product launch of a company, then data, risk scores and permissions across the enterprise may be automatically updated to allow new permissions, such as larger loans to be granted/additional stocks to be purchased, or additional/increased credit lines to be provided by the enterprise network or users of enterprise network/system to be issued to the company/entity/individual concerned.

In various embodiments the sentiment score can be used to provide actionable alert notifications on a user interface of a system, network or enterprise user/administrator (referred to herein as “user”). In one non-limiting example, a new or updated score, such as a risk or credit score based on receiving, processing and deriving new or updated sentiments about an individual/entity and sentiments associated with the individual/entity. For example, a notification may indicate an alert of sudden plethora of new sentiment regarding a specific entity or individual (for example a high volume of good sentiment following a successful product launch of an entity). There may be options provided to the user to either delve further into the information underlying the sentiment or take other action regarding the individual/entity.

Also, actionable notifications can be displayed to certain users, for example those users configured/permitted to receive such notifications and/or have an ability to approve or reject updates, for example to scores or attributes in databases, or to approve/reject actions such as increasing the credit lines or issuing funds or loans to the individual/entity. Users can be provided notification(s), for example on an interactive graphical user interface on a device on the system or enterprise, where the notification can include any of: sentiment information, reasons of why sentiment information is being classified a certain way, scores affected by sentiment information, ratings being affected by updated scores and/or sentiment information, selectable actionable options to apply actions such as allowing database updates, accepting, rejecting of: incoming sentiment information, scores, or ratings, allowing incorporation or applying/implementing new/updated sentiment information, scores, or ratings into actions, decisions, rules, or permissions relating to specific individuals or entities or adjusting any of the aforementioned to increase or decrease the scope of what permissions are available to an individual/entity for example.

While the present technology is susceptible of aspects in many different forms, there is shown in the drawings and will herein be described in detail several specific aspects with the understanding that the present disclosure is to be considered as an exemplification of the principles of the present technology and is not intended to limit the technology to the illustrated aspects.

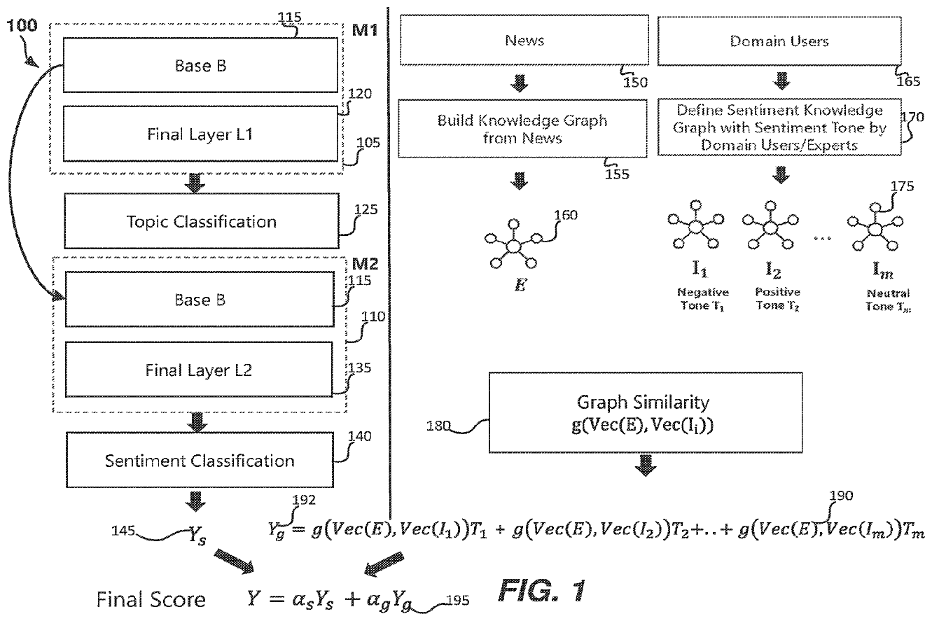

FIG. 1 is a diagram of a method 100 to determine a sentiment in digital information, according to at least one aspect of the present disclosure. The method 100 to determine a sentiment in digital information is based on a combination of two separate portions. A first portion of the method 100 includes training machine learning networks. In one aspect, the first portion includes two machine learning networks, a first machine learning network 105 (also referred to herein as “M1”) and a second machine learning network 110 (also referred to herein as “M2”). M1 105 defines two separate neural layers, a base layer 115, and a final layer 120 (also referred to herein as “L1”). M1 105 is trained to provide general topic or domain classifications 125 as outputs from data inputs fed into the two layers base layer 115, and final layer L1 120. Once sufficient training occurs, the base layer 115 is incorporated into M2 110, which in turn is trained to provide a domain-specific sentiment classification 140 with a combination of trained base layer 115 and a final layer L2 135. Together, the trained base layer 115 and the final layer L2 135 make up M2 110. The sentiment classification that is output by M2 110 is represented by a vector or a classification score Ys 145. In several aspects of the present disclosure, the same inputs, or inputs from the same or similar pool of inputs, are used for both M1 105 and M2 110, however the targets or target outputs for M1 105 and M2 110 are different. In various aspects, M1 105 has a target of topic classification or categorization of the inputs while M2 110 has a target of sentiment classification of the inputs, for example. This technique allows M1 105, and its base layer to be trained on easier tasks and targets, i.e., to classify topics in freely available digital information, and then use the already trained base layer as part of M2 110 to produce different outputs requiring more advanced training, i.e., sentiment classification that is domain specific.

A second portion of the method 100 includes determining sentiment in digital information that is non-domain specific. The second portion of the method 100 treats sentiment classification as a graph-matching task, and includes extracting information or news from at least one source 150. In one aspect, this information is digital information, for example. The source 150 can be an information source, a database, a news source, and the information may be formatted as audio, video, image, textual, or any other suitable digital format. In various aspects, the information that is extracted, derived, or received from the at least one source 150 may be news or current events information. This information is used to build 155 a non-domain specific knowledge graph 160 that comprises the various components of the information, or news that is derived. For example, the knowledge graph 160 may represent or be built on relationships between entities, events, places, names, dates, emotions, topics, and the like, any of which could be represented on the knowledge graph 160, depending on what associations the knowledge graph 160 is intending to present. The knowledge graph 160 may represent or include one or more news information pieces or information from various news sources 150. In various aspects, the digital information that is received or extracted from the news source 150 pertains to one entity, such as a company, an individual, an agency, a state, a government, and the like.

In various aspects, users 165 that may include domain users define 170 sentiment of various news pieces, information, or current events, or other forms of digital information. These defined sentiments are then used by the system to create or build sentiment knowledge graphs 175 (also referred to herein as “sentiment graphs”) that include various graphs representing different sentiment types. The system may refer to one or more computing devices or combinations of computing devices (e.g., processors, servers, client devices, software applications, components of such, and/or the like).

Exemplary sentiment types may include, but are not limited to, positive, negative, neutral, slightly negative, moderately negative, highly negative, slightly positive, moderately positive, and highly positive. The knowledge graph 160 is then compared with the various sentiment knowledge graphs 175 via a graph similarity function 180 g(Vec(E), Vec(Ii)), wherein Vec(E) represents the vector or value(s) of the knowledge graph 160 and Vec(Ii) represents the vector or value(s) (or vectorized values) of the sentiment graph 175 that is being compared to the knowledge graph 160. The graph similarity function may be weighted or multiplied by a defined sentiment extracted from or attributed to the relevant sentiment graph 175 to produce a graph sentiment score of that particular sentiment graph 175. Each of the graph similarity functions 180 are weighted with the defined sentiment of the relevant sentiment knowledge graph 175. The graph similarity functions 180 are then combined 190 with the other graph sentiment scores to derive a total graph sentiment score Yg 192. The total graph sentiment score Yg 192 is then combined with the machine learning sentiment score Ys 145 to produce a final sentiment score Y 195 representing the sentiment of an entity. Each one of the total graph sentiment scores Yg 192 and classification score Ys 145 also may be weighted when combined to produce the final sentiment score 195.

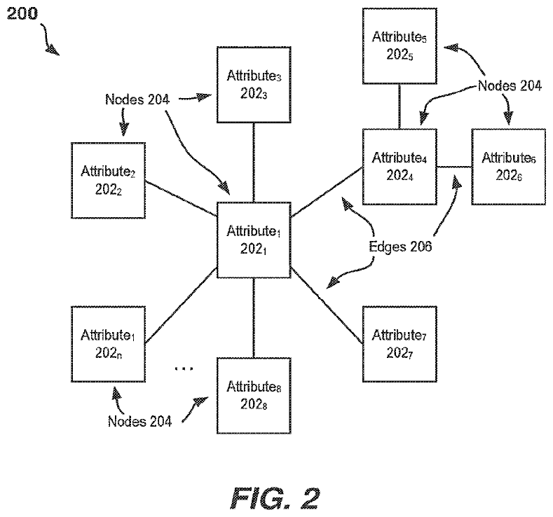

FIG. 2 illustrates an entity graph 200 representing a knowledge or sentiment knowledge graph, according to at least one aspect of the present disclosure. The entity graph 200 includes several nodes 204. Each of the nodes 204 corresponds to one of the attributes 202 from an attribute set (e.g., the attribute set comprising attribute₁ 202₁, attribute₂ 202₂, attribute₃ 202₃, attribute₄ 202₄, attribute₅ 202₅, attribute₆ 202₆, attribute₇ 202₇, attribute₈ 202₈, . . . and attribute 202ₙ). The entity graph 200 may define news or information that may be related to an entity, an unknown entity graph, or a known entity graph, as well as sentiments as defined by users or readers of the information. Thus, the attributes 202 can correspond to entities, entity attributes, news stories, names, locations, sentiments, locations, dates, events, and other news information extracted from an information source, news source, or other database. Moreover, any number (e.g., any positive integer) of attributes can be included in an attribute set. Accordingly, the entity graph 200 can include any number (e.g., any positive integer) of nodes 204.

Still referring to FIG. 2, the structure of the entity graph 200 is determined by the placement of edges 206. Generally, each node 204 is connected to at least one other node 204 by an edge 206. Some nodes 204 may be connected to multiple other nodes 204 via multiple edges. For example, the node 204 corresponding to attribute₂ 202₂ is only connected to the node 204 corresponding to attribute₁ 202₁ via an edge 206. Conversely, the node 204 corresponding to attribute₁ 202₁ is connected via edges 206 to the nodes 204 corresponding to attribute₂ 202₂, attribute₃ 202₃, attribute₄ 202₄, attribute₇ 202₇, attribute₈ 202₈, and attributeₙ 202ₙ. Although one specific entity graph structure is depicted in the non-limiting aspect of FIG. 2, the entity graph 200 can have any structure, with each node 204 being connected via an edge 206 to one or more of any of the other nodes 204.

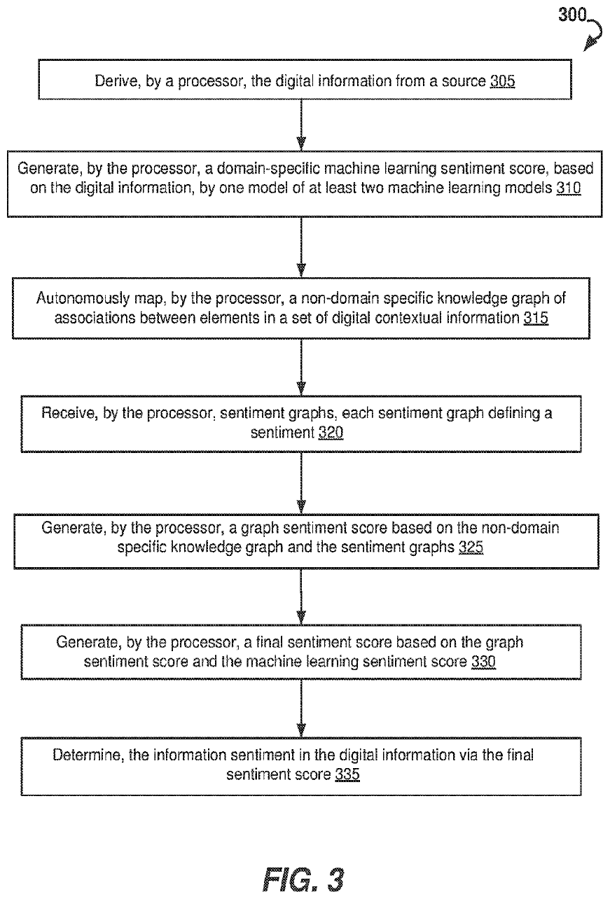

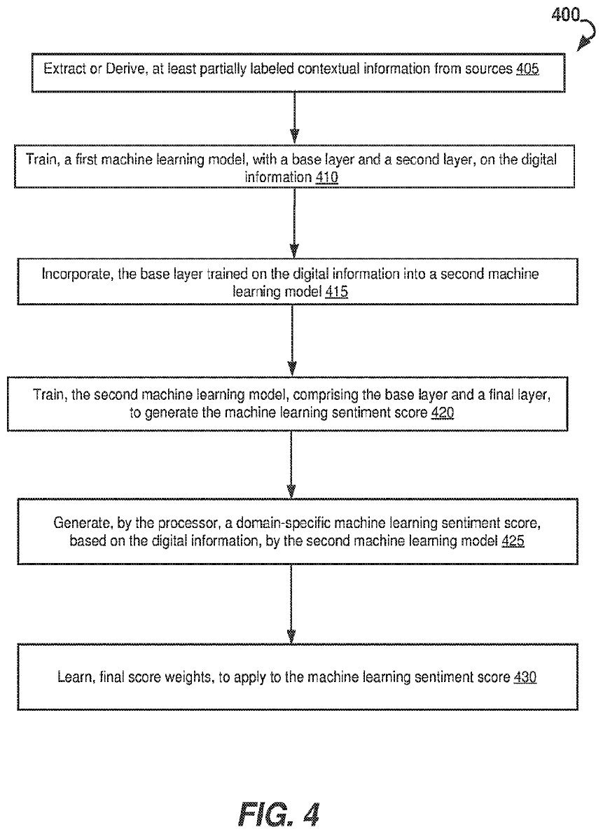

FIG. 3 is a logic flow diagram of a method 300 for determining sentiment in digital information, according to at least one aspect of the present disclosure. According to the method 300, information is first derived 305 from a source. The source may be a news source, information source, or any other contextual information source, in various aspects this source is a digital information source. This information is then used to generate 310, by one or more processors, a domain-specific machine learning (also referred to herein as “ML”) sentiment score based on the digital information, by one model of at least two machine learning models. The two models are illustrated in FIGS. 1 as M1 105 and M2 110, and the training of the machine learning models and the generation of the domain-specific sentiment score is described in detail in FIG. 4.

Still with reference to FIG. 3, while a domain-specific ML score is provided by the first portion of the method 300, a second portion of method 300 treats sentiment classification as a graph matching task. The method 300 then autonomously or automatically maps 315, generates, or builds at least one knowledge graph that describes how various entities are related to, associated, or interact with each other. This mapping 315 could be undertaken from the derived 305 information or from a separate information extraction or derivation step (not shown), and/or from separate information source(s). The information source(s) may be digital information sources that are internal or external (for example third party) databases, servers, or systems. The knowledge graphs are mapped 315 automatically by the system to show various relationships between several entities in one or more graphs. The types of relationships or entities may be customizable in the system. The mapping 315 of the knowledge graphs may be used to find or identify one or more entities from digital information source(s).

In some aspects, one knowledge graph is built to show entity interactions and associations, while in other aspects, knowledge graphs are created by autonomous mapping 315 to show association between various different elements including but not limited to entities, events, places, names, dates, or any other relevant information that is derived from the news sources. The system, a database, server, or other processor may then receive 320 other sentiment graphs that have been generated based on information, digital information, or feedback provided by domain users, whereby users define or determine sentiment in various different articles, information pieces, news information, or contextual information pieces. In various aspects, the graphs are internally generated and use sources separate from the sources used to autonomously map 315 the knowledge graph. These sentiment graphs are used to represent different sentiment scores or sentiment states and may correspond with, for example, positive sentiment or tone, a negative sentiment, or a neutral sentiment. By comparing the autonomously mapped 315 knowledge graph with the received 320 sentiment graphs, via a graph similarity function, for example, the graph similarity function 180 shown in FIG. 1, a non-domain specific graph sentiment score is generated 325.

In some aspects, the similarity between the graphs is calculated based on graph embedding and then comparing the embedded vector similarity with distance measurements. The system then automatically generates 330 a final sentiment score by combining the domain-specific machine learning sentiment score and the non-domain specific graph sentiment score. Weightings may be added to either of these scores, these weights may be a product of training by machine learning networks, or assigned based on other factors, observations, heuristics, or other settings. The final generated sentiment score can be used to determine the sentiment of the derived or extracted digital information or the information sources that the knowledge and/or sentiment graphs were based on. In various aspects, the final generated sentiment score is related to a specific entity that may be mentioned in the digital information.

FIG. 4 is a logic flow diagram of a method 400 for training machine learning networks, according to at least one aspect of the present disclosure. The method 400 details one aspect in which a domain-specific machine learning sentiment score can be generated by training two machine learning models as described in FIG. 3 and in particular at step 310 of the method 300 illustrated in FIG. 3. With reference now to FIGS. 3 and 4, information that is at least partially labeled contextual information is extracted, or derived 405/305 from sources. The information that is derived or extracted 305 (FIG. 3), or 405 (FIG. 4) may be derived or extracted from any information source, including a database, a news source, and the information could be in various formats including audio, video, image, textual, or other suitable digital formats. In some aspects of the present disclosure, the information that is extracted, derived, or received from information sources may be general contextual information including news or current events information. This information is already tagged, or populated with categories or categorized in one or more ways. For example, this information may be tagged with tags such as “stock price.” The extraction of this information may include extraction of contextual information that may for example, describe the topic of a news article, and extract other information that is generally available and provided by news sources and at least partially labeled with tags or categories.

With reference now to FIGS. 1 and 4, because the information is already at least partially tagged, the information that is extracted or derived 405 can be used as an input for a basic machine learning model to train on, such as M1 105 (FIG. 1), without any additional domain specific knowledge. In various aspects, this partially labeled and publicly available information is leveraged to train 410 a first machine learning model, corresponding to M1 105. The first machine learning model may comprise two layers, a base layer and a final layer, and is trained 410 to determine the topic or classification of the information that was derived or extracted in 405 using a large amount of labeled data.

Still with reference to FIGS. 1 and 4, after the model M1 105 (FIG. 1) is trained 410, its already-trained base layer is copied or incorporated 415 into a second machine learning model, corresponding to M2 110 (FIG. 1). Because the base layer has already been finely tuned in M1 105 to classify topics or categories, or trained to provide outputs on any other suitable target based on training on a large amount of at least partially labeled data, the model M2 110, and especially its final layer L2 135 (FIG. 1) may be tuned to train 420 solely to determine, output, or generate 425 sentiment or sentiment score(s) that are domain, category, or topic specific. For example, this second model M2 110 may generate an output score, value, or vector that indicates whether an article, or other information piece is negative, positive, or neutral on the categories or topics that the model has identified. This output is a domain specific machine learning sentiment score or classification Ys 145 (FIG. 1). Finally, in various aspects, determining weights to apply to the outputs may be learned during the training of either M1 105 or M2 110, and also may be output by M2 110. These weight(s) may be applied 430 to the generated 425 domain-specific machine learning sentiment score.

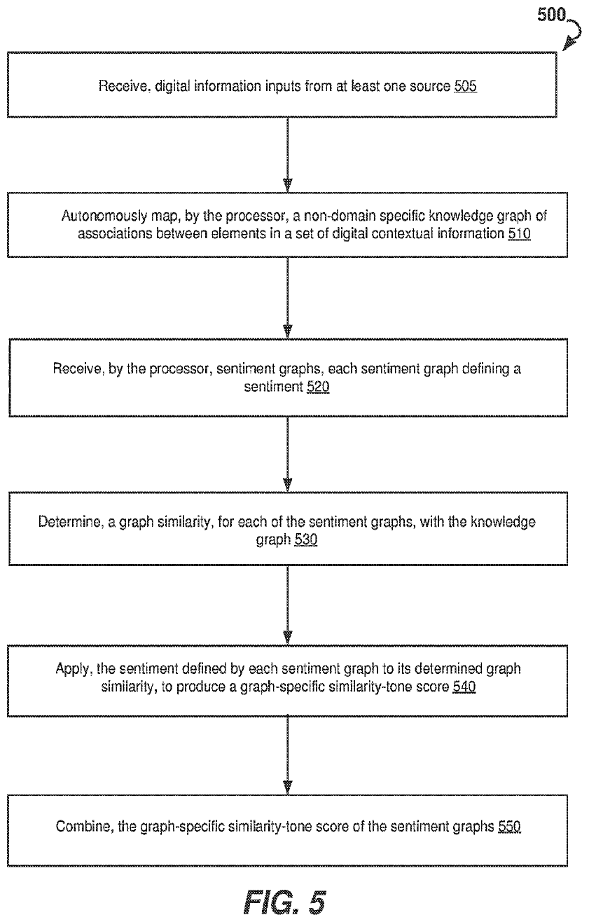

FIG. 5 is a logic flow diagram of a method 500 for generating non-domain specific sentiment scores based on mapped graphs, according to at least one aspect of the present disclosure. According to the method 500, digital information inputs are first received 505 by a computing device, server, or system, this digital information may be the same as the digital information in FIGS. 3 and 4 references as 305 and 405, or from the same source(s), or it may be other digital information, received separately from other sources. The system then autonomously maps 510 by a processor, server, or computing device, a non-domain specific knowledge graph of associations between elements in a set of digital contextual information. This autonomous mapping 510 provides a knowledge graph of associations between different elements identified in the digital information. The elements may be entities, wherein the mapping associates the entities with each other, while in other aspects, the elements may be various other features or elements, such as names, places, dates, events, entities, and the knowledge autonomous mapping 510 connects all of these various features with each other.

According to method 500, the processor sentiment graphs or sentiment knowledge graphs receive 520 each sentiment graph defining a sentiment or tone of the information. These may be sentiment graphs produced autonomously by a computing device, server, or system, or they may be produced by domain-specific users that assign sentiment scores, or sentiment attributes to each digital information. The various sentiment scores, attributes, and/or sentiment/tone provided then may be autonomously mapped 510 into a sentiment graph that represent the tone or sentiment of the digital information. One example of the structure of a knowledge graph or a sentiment graph is shown FIG. 2 (see entity graph 200). Examples include receiving sentiment scores, or sentiment descriptions from domain users such as on various scenarios and/or news or current items. Sentiments could be negative, positive, neutral, or in between these parameters.

Another example may include a domain-user or autonomous system producing a score on each information item or digital information, and the sentiment scores related to each item are then autonomously mapped onto a graph where the graph represents an average sentiment score, which may in turn represents positive, negative, neutral sentiments (or sentiments in between these categories). A graph similarity function may be applied to determine 530 the similarity between the mapped knowledge graph and the various sentiment graphs via a graph similarity function that may be represented, for example, by the graph similarity function 180 shown in FIG. 1, g(Vec(E), Vec(Ii)). For each graph similarity function, that compares a specific sentiment graph and the knowledge graph, a sentiment score of the specific sentiment graph is applied 540. The applied 540 sentiment score may be multiplied by the graph similarity function to produce a product between each relevant sentiment graph-knowledge graph combination. The product of each sentiment score and graph similarity function is combined with the products of all the other sentiment scores and graph similarity functions, for example as seen in equation 190, FIG. 1 to generate 550 a graph-specific similarity-tone score of the sentiment graphs Yg 192 in FIG. 1.

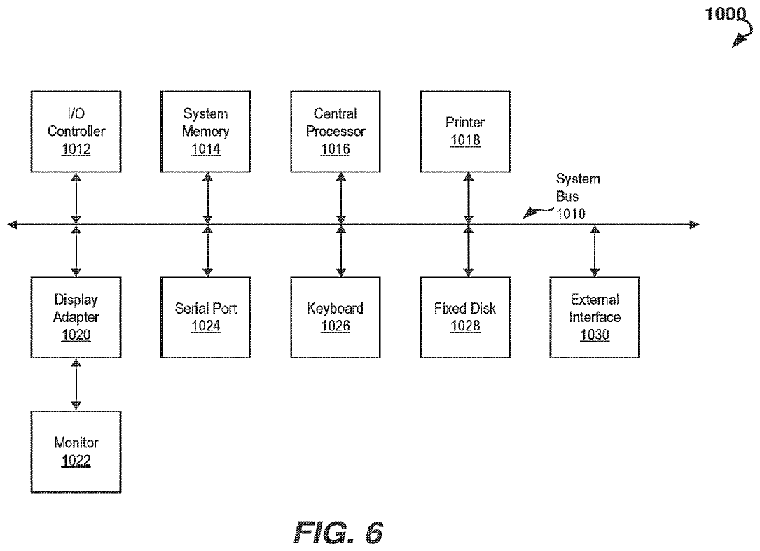

FIG. 6 is a block diagram of a computer apparatus 1000, according to at least one aspect of the present disclosure. The computer apparatus 1000 or subsystems thereof may be used to perform the methods and functions described herein. The example computer apparatus 1000 also referred to herein as subsystems 1000 are interconnected via a system bus 1010. Additional subsystems such as a printer 1018, keyboard 1026, fixed disk 1028 (or other memory comprising computer readable media), monitor 1022, which is coupled to display adapter 1020, and others are shown. Peripherals and input/output (I/O) devices, which couple to I/O controller 1012 (which can be a processor or other suitable controller), can be connected to the computer system by any number of means known in the art, such as serial port 1024. For example, serial port 1024 or external interface 1030 can be used to connect the computer apparatus to a wide area network such as the Internet, a mouse input device, or a scanner. The interconnection via system bus 1010 allows the central processor 1016 to communicate with each subsystem and to control the execution of instructions from system memory 1014 or the fixed disk 1028, as well as the exchange of information between subsystems. The system memory 1014 and/or the fixed disk 1028 may embody a computer readable medium.

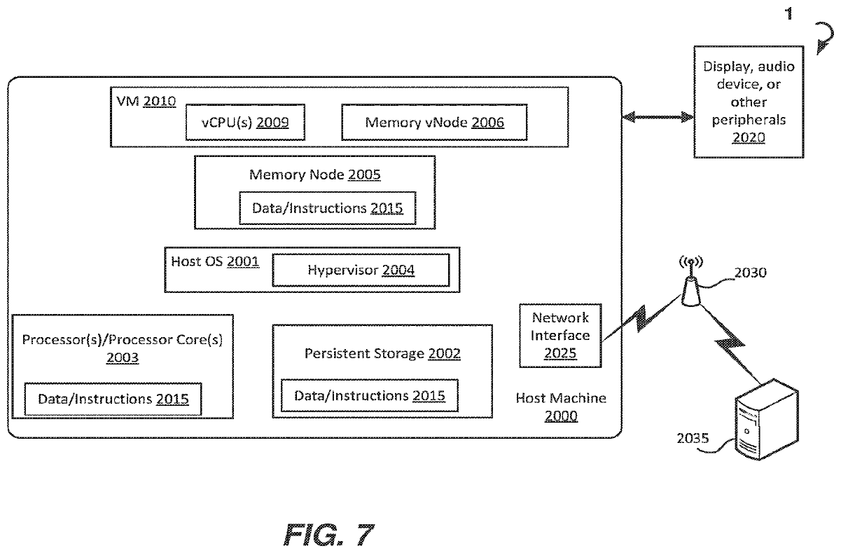

FIG. 7 is a diagrammatic representation of an example system 1 that includes a host machine 2000 within which a set of instructions to perform any one or more of the methodologies discussed herein may be executed, according to at least one aspect of the present disclosure. In various aspects, the host machine 2000 operates as a standalone device or may be connected (e.g., networked) to other machines. In a networked deployment, the host machine 2000 may operate in the capacity of a server or a client machine in a server-client network environment, or as a peer machine in a peer-to-peer (or distributed) network environment. The host machine 2000 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 1 includes the host machine 2000, running a host operating system (OS) 2001 on a processor or multiple processor(s)/processor core(s) 2003 (e.g., a central processing unit (CPU), a graphics processing unit (GPU), or both), and various memory nodes 2005. Host OS 2001 may include a hypervisor 2004 which is able to control the functions and/or communicate with a virtual machine (“VM”) 2010 running on machine readable media. VM 2010 may also include a virtual CPU or vCPU 2009. Memory nodes 2005, and 2007 may be linked or pinned to virtual memory nodes or vNodes 2006 respectively. When a memory node 2005 is linked or pinned to a corresponding virtual node 2006, then data may be mapped directly from the memory nodes 2005 to their corresponding vNodes 2006.

All the various components shown in host machine 2000 may be connected with and to each other, or communicate to each other via a bus (not shown) or via other coupling or communication channels or mechanisms. The host machine 2000 may further include a video display, audio device or other peripherals 2020 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 2002 (also referred to as disk drive unit), and a network interface device 2025. The host machine 2000 may further include a data encryption module (not shown) to encrypt data. The components provided in the host machine 2000 are those typically found in computer systems that may be suitable for use with aspects of the present disclosure and are intended to represent a broad category of such computer components that are known in the art. Thus, the system 1 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 2002 also may be a Solid-state Drive (SSD), a hard disk drive (HDD), e.MMC, and UFS, or other computer or machine-readable medium on which is stored one or more sets of instructions and data structures (e.g., data or instructions 2015) embodying or utilizing any one or more of the methodologies or functions described herein. The instructions 2015 may also reside, completely or at least partially, within the main memory node 2005 and/or within the processor(s) 2003 during execution thereof by the host machine 2000. The processor(s) 2003, and memory nodes 2005 may also comprise machine-readable media.

The instructions 2015 may further be transmitted or received over a network 2030 via the network interface device 2025 utilizing any one of several well-known transfer protocols (e.g., Hyper Text Transfer Protocol (HTTP). The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the machine 2000 and that causes the machine 2000 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 3030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 2000, with each server 2035 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. An automated computer implemented method to determine information sentiment in digital information, the method comprising deriving, by a processor, the digital information from a source; generating, by the processor, a domain-specific machine learning sentiment score, based on the digital information, by one model of at least two machine learning models; autonomously mapping, by the processor, a non-domain specific knowledge graph of associations between elements in a set of digital contextual information; receiving, by the processor, sentiment graphs, each sentiment graph defining a sentiment; generating, by the processor, a graph sentiment score based on the non-domain specific knowledge graph and the sentiment graphs; generating, by the processor, a final sentiment score based on the graph sentiment score and the domain-specific machine learning sentiment score; and determining, by the processor, the information sentiment in the digital information via the final sentiment score.

Clause 2. The method of Clause 1 further comprising automatically updating entity attributes, by the processor, in at least one of a database or server, based on the final sentiment score.

Clause 3. The method of any one of Clauses 1-2, further comprising training, by the processor, a first machine learning model, with a base layer and a second layer, on the digital information; incorporating, by the processor, the base layer trained on the digital information into a second machine learning model; and training, by the processor, the second machine learning model, comprising the base layer and a final layer, to generate the domain-specific machine learning sentiment score.

Clause 4. The method of any one of Clauses 1-3, wherein the training of the first machine learning model, includes training the first machine learning model to classify topics of the digital information.

Clause 5. The method of any one of Clauses 1-4, wherein the generating of the graph sentiment score comprises determining, by the processor, a graph similarity, for each of the sentiment graphs, with the non-domain specific knowledge graph; applying, by the processor, the sentiment defined by each of the sentiment graphs to its determined graph similarity, to produce a graph-specific similarity-tone score; and combining, by the processor, the graph-specific similarity-tone score of the sentiment graphs.

Clause 6. The method of any one of Clauses 1-5, wherein the generating of the final sentiment score comprises applying, by the processor, a weighting to the graph sentiment score to generate a weighted graph sentiment score; applying, by the processor, another weighting to the domain-specific machine learning sentiment score to generate a weighted domain-specific machine learning sentiment score; and combining, by the processor, the weighted graph sentiment score and the weighted domain-specific machine learning sentiment score.

Clause 7. The method of any one of Clauses 1-6, wherein the elements comprise at least one of an entity, a name, a location, a time, or an event.

Clause 8. The method of any one of Clause 1-7, wherein at least a portion of the digital information is labeled.

Clause 9. The method of anyone of Clauses 1-8, wherein the defined sentiment of each of the sentiment graphs relates to a digitally provided contextual scenario.

Clause 10. An automated system to update stored entity attributes based on a determined sentiment for information, the system comprising a database containing entity attributes; a processor; and a computer readable medium storing instructions executable by the processor, to input, by the processor, domain-specific digital information received from a source into a trained domain-specific machine learning model; output, by the processor, a domain-specific sentiment score produced by the domain-specific machine learning model; input, by the processor, digital news information into a knowledge graph representing an entity; update, by the processor, the knowledge graph with the digital news information; determine, by the processor, a similarity of the knowledge graph with a defined sentiment graph to produce a graph sentiment score; generate, by the processor, an entity sentiment score, based on the domain-specific sentiment score and the graph sentiment score; look up by the processor, an entity sentiment score entry stored in the database; and based on a difference between the entity sentiment score and the entity sentiment score entry, automatically update, by the processor, the entity sentiment score entry in the database.

Clause 11. The system of Clause 10, wherein the update of the entity sentiment score entry includes at least one of deleting, altering, adding to, subtracting from, or applying weights to the entity sentiment score entry in the database.

Clause 12. A connected system consisting of a cluster of nodes to create and update entity profiles based on live information, the system comprising a plurality of nodes connected within the cluster; a first node of the plurality of nodes, in communication with a digital information channel, the first node comprising instructions executable to receive a digital information associated with an entity from the digital information channel; input the digital information into a trained ML network to generate a sentiment classification; output the sentiment classification into a processing node of the plurality of nodes; and a second node of the plurality of nodes in communication with a news source, the second node comprising instructions to receive digital news content from the news source; and map a knowledge graph associated with the entity based on the digital news content.

Clause 13. The system of Clause 12 wherein the second node is in further communication with a user server to receive from the user server sentiment classifications of content, wherein the sentiment classifications are generated by domain users.

Clause 14. The system of any one of Clauses 12-13, wherein the user server comprises instructions to receive new sentiment classifications from the domain users; and update a user-sentiment database storing the sentiment classifications, with the new sentiment classifications received from the domain users.

Clause 15. The system of any one of Clauses 12-14, wherein the second node comprises further instructions to receive the sentiment classifications from the domain user server; and map sentiment graphs based on the sentiment classifications, wherein each sentiment graph contains a sentiment tone.

Clause 16. The system of any one of Clauses 12-15 wherein the second node comprises further instructions to generate an entity sentiment score, based on a similarity between the knowledge graph and at least one sentiment graph of the sentiment graphs; and output the entity sentiment score into the processing node.

Clause 17. The system of any one of Clauses 12-16, wherein the processing node, comprises instructions to receive the sentiment classification from the first node; receive the entity sentiment score from the second node; determine a final entity sentiment score, based on the sentiment classification and the entity sentiment score; and push the final entity sentiment score to a database node of the plurality of connected nodes, the database node storing a profile of the entity.

Clause 18. The system of any one of Clauses 12-17, wherein the database node comprises instructions to receive the final entity sentiment score from the processing node; and update the profile of the entity stored in the database node with the final entity sentiment score.

Clause 19. The system of any one of Clauses 12-18, wherein the first node comprises instructions to detect the digital information from the digital information channel.

Clause 20. The system of any one of Clauses 12-19, wherein the second node comprises instructions to detect the digital news content from the news source.

The foregoing detailed description includes references to the accompanying drawings, which form a part of the detailed description. The drawings show illustrations in accordance with exemplary aspects. These example aspects, which are also referred to herein as “examples,” are described in enough detail to enable those skilled in the art to practice the present subject matter.

The various aspects described above, are presented as examples only, and not as a limitation. The descriptions are not intended to limit the scope of the present technology to the forms set forth herein. To the contrary, the present descriptions are intended to cover such alternatives, modifications, and equivalents as may be included within the scope of the present technology as appreciated by one of ordinary skill in the art.

While specific aspects of, and examples for, the system are described above for illustrative purposes, various equivalent modifications are possible within the scope of the system, as those skilled in the relevant art will recognize. For example, while processes or steps are presented in a given order, alternative aspects may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The aspects can be combined, other aspects can be utilized, or structural, logical, and electrical changes can be made without departing from the scope of what is claimed. It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. The detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.).

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect.” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited in the form disclosed. Many modifications and variations will be apparent to those of ordinary skill in the art without departing from the scope of the claimed subject matter. Exemplary aspects were chosen and described to best explain the principles of the present technology and its practical application, and to enable others of ordinary skill in the art to understand the various aspects of the present disclosure with various modifications as are suited to the particular use contemplated.

1. An automated computer implemented method to determine a sentiment of information in digital information, the method comprising:
deriving, by at least one processor, digital information from a source;
generating, by the at least one processor, a domain-specific machine learning sentiment score, based on the digital information, by one model of at least two machine learning models;
autonomously mapping, by the at least one processor, a non-domain specific knowledge graph of associations between elements in a set of digital contextual information;
receiving, by the at least one processor, sentiment graphs, each sentiment graph of the sentiment graphs defining a sentiment;
generating, by the at least one processor, a graph sentiment score based on the non-domain specific knowledge graph and the sentiment graphs;
generating, by the at least one processor, a final sentiment score based on the graph sentiment score and the domain-specific machine learning sentiment score; and
determining, by the at least one processor, the sentiment of information in the digital information based on the final sentiment score.

2. The method of claim 1 further comprising:
automatically updating entity attributes, by the at least one processor, in at least one of a database or a server, based on the final sentiment score.

3. The method of claim 1, further comprising:
training, by the at least one processor, a first machine learning model, with a base layer and a second layer, on the digital information;
incorporating, by the at least one processor, the base layer trained on the digital information into a second machine learning model; and
training, by the at least one processor, the second machine learning model, comprising the base layer and a final layer, to generate the domain-specific machine learning sentiment score.

4. The method of claim 3, wherein the training of the first machine learning model, includes training the first machine learning model to classify topics of the digital information.

5. The method of claim 1, wherein the generating of the graph sentiment score comprises:
determining, by the at least one processor, a graph similarity, for each sentiment graph of the sentiment graphs, with the non-domain specific knowledge graph;
applying, by the at least one processor, the sentiment defined by each sentiment graph of the sentiment graphs to its determined graph similarity, to produce a graph-specific similarity-tone score; and
combining, by the at least one processor, the graph-specific similarity-tone score of each sentiment graph of the sentiment graphs.

6. The method of claim 1, wherein the generating of the final sentiment score comprises:
applying, by the at least one processor, a weighting to the graph sentiment score to generate a weighted graph sentiment score;
applying, by the at least one processor, another weighting to the domain-specific machine learning sentiment score to generate a weighted domain-specific machine learning sentiment score; and
combining, by the at least one processor, the weighted graph sentiment score and the weighted domain-specific machine learning sentiment score.

7. The method of claim 1, wherein the elements comprise at least one of an entity, a name, a location, a time, or an event.

8. The method of claim 1, wherein at least a portion of the digital information is labeled.

9. The method of claim 1, wherein the sentiment defined by each sentiment graph of the sentiment graphs relates to a digitally provided contextual scenario.

10. An automated system to update stored entity attributes based on a determined sentiment for information, the automated system comprising:
a database, containing entity attributes;
at least one processor; and
a computer readable medium storing instructions executable by the processor, to:
input, by the at least one processor, domain-specific digital information received from a source into a trained domain-specific machine learning model;
output, by the at least one processor, a domain-specific sentiment score produced by the trained domain-specific machine learning model;
input, by the at least one processor, digital news information into a knowledge graph representing an entity;
update, by the at least one processor, the knowledge graph with the digital news information;
determine, by the at least one processor, a similarity of the knowledge graph with a defined sentiment graph to produce a graph sentiment score;
generate, by the at least one processor, an entity sentiment score, based on the domain-specific sentiment score and the graph sentiment score;
look up, by the at least one processor, an entity sentiment score entry stored in the database; and
based on a difference between the entity sentiment score and the entity sentiment score entry, automatically update, by the processor, the entity sentiment score entry in the database.

11. The automated system of claim 10, wherein the automatic update of the entity sentiment score entry in the database comprises at least one of deleting, altering, adding to, subtracting from, or applying weights to the entity sentiment score entry in the database.

12. A connected system consisting of a cluster of nodes to create and update entity profiles based on live information, the connected system comprising:
a plurality of nodes connected within the cluster;
a first node of the plurality of nodes, in communication with a digital information channel, the first node comprising instructions executable to:
receive digital information associated with an entity from the digital information channel;
input the digital information into a trained machine learning (ML) network to generate a sentiment classification;
output the sentiment classification into a processing node of the plurality of nodes; and
a second node of the plurality of nodes in communication with a news source, the second node comprising instructions to:
receive digital news content from the news source; and
map a knowledge graph associated with the entity based on the digital news content.

13. The connected system of claim 12 wherein the second node is in further communication with at least one domain user server to receive, from the domain user server, sentiment classifications of content, wherein the sentiment classifications are generated by domain users.

14. The connected system of claim 13, wherein the domain user server comprises instructions to:
receive new sentiment classifications from at least one domain user; and
update a user-sentiment database storing the sentiment classifications, with the new sentiment classifications received from the at least one domain user.

15. The connected system of claim 13, wherein the second node comprises further instructions to:
receive the sentiment classifications from the domain user server; and
map sentiment graphs based on the sentiment classifications, wherein each sentiment graph contains a sentiment tone.

16. The connected system of claim 15 wherein the second node comprises further instructions to:
generate an entity sentiment score, based on a similarity between the knowledge graph and at least one sentiment graph of the sentiment graphs; and
output the entity sentiment score into the processing node.

17. The connected system of claim 16, wherein the processing node, comprises instructions to:
receive the sentiment classification from the first node;
receive the entity sentiment score from the second node;
determine a final entity sentiment score, based on the sentiment classification and the entity sentiment score; and
push the final entity sentiment score to a database node of the plurality of nodes, the database node storing a profile of the entity.

18. The connected system of claim 17, wherein the database node comprises instructions to:
receive the final entity sentiment score from the processing node; and
update the profile of the entity stored in the database node with the final entity sentiment score.

19. The connected system of claim 12, wherein the first node comprises instructions to:
detect the digital information from the digital information channel.

20. The connected system of claim 12, wherein the second node comprises instructions to:
detect the digital news content from the news source.
